(19) United States
(12) Patent Application Publication
(10) Pub. No.: US 2025/0012923 A1
(43) Pub. Date: Jan. 9, 2025

(54) LIDAR DEFECT DETECTION SYSTEM AND METHOD FOR USE IN CAN MANUFACTURING ASSEMBLIES

(71) Applicant: Stolle Machinery Company, LLC, Centennial, CO (US)

(72) Inventor: Sayon Chandrakanthan, Lakewood, CO (US)

(73) Assignee: Stolle Machinery Company, LLC, Centennial, CO (US)

(21) Appl. No.: 18/219,204

(22) Filed: Jul. 7, 2023

(51) Int. Cl. G01S 17/894; G01N 21/89; G01N 21/892; G01N 21/952; G01S 7/481; G06T 7/00

(52) U.S. Cl. CPC G01S 17/894; G01N 21/8901; G01N 21/892; G01N 21/952; G01S 7/4817; G06T 7/0004; G01N 2021/8924; G06T 2207/10028

(57) ABSTRACT

A LiDAR (Light Detection and Ranging) detection system for use in a can manufacturing assembly. The LiDAR defect detection system includes a plurality of LiDAR sensors disposed at outputs of one or more equipment in the can manufacturing assembly and structured to scan and create at least three-dimensional (3D) images of output cans at the outputs of the one or more equipment; and a controller communicatively coupled to the LiDAR sensors and structured to collect data including at least the 3D images and analyze the data to determine if one or more output cans are defective.

### FIELD OF THE INVENTION

The disclosed concept relates generally to a defect detection system and method and, more particularly, to a system and method of detecting product defects using LiDAR in can manufacturing assemblies.

### BACKGROUND OF THE INVENTION

The process of food and beverage metal packing includes various stages (e.g., without limitation, bodymaking, trimming, washing, printing, necking, flanging, inspecting, filling, etc.) of can manufacturing. For example, an aluminum can begins as a disk of aluminum, also known as a “blank,” that is punched from a sheet or coil of aluminum by a cupper. That is, the sheet is fed into a dual action press where a “blank” disc is cut from the sheet by an outer slide/ram motion. An inner slide/ram then pushes the “blank” through a draw process to create a cup 102 (shown in FIG. 3). The cup 102 has a bottom and a depending sidewall. The cup 102 is fed into a bodymaker 100, one example of which is shown in FIG. 3, which performs a redraw and ironing operation. More specifically, the cup 102 is disposed in a can forming machine at the mouth of a die pack 106 having substantially circular openings therein. The cup 102 is held in place by a redraw sleeve, which is part of the redraw assembly 118. The redraw sleeve is a hollow tubular construct that is disposed inside the cup 102 and biases the cup against the die pack 106. More specifically, the first die in the die pack 106 is the redraw die, which is not a part of the redraw assembly. The cup 102 is biased against the redraw die by the redraw sleeve. Other dies, the ironing dies, are disposed behind, and axially aligned with, the redraw die. The ironing dies and redraw die are not part of the redraw assembly. An elongated, cylindrical ram assembly includes a carriage 107 that supports a ram 109 with a punch at the forward, distal end. The ram 109 and punch are aligned with, and structured to travel through, the openings in the redraw die and the ironing dies. At the end of the die pack 106 opposite the ram is a domer “D”. The domer is a die structured to form a concave dome in the bottom of the cup/can. Further, the ram 109 is supported by a bearing “B” disposed before the die pack 106. A seal assembly “S” is disposed between the bearing assembly “B” and the die pack 106. The seal assembly “S” removes coolant and lubricant from the ram.

Thus, in operation, a cup is disposed at one end of the die pack. The cup, typically, has a greater diameter than a finished can as well as a greater wall thickness. The redraw sleeve is disposed inside of the cup and biases the cup bottom against the redraw die. The opening in the redraw die has a diameter that is smaller than the cup. The elongated ram body, and more specifically the punch, passes through the hollow redraw sleeve and contacts the bottom of the cup. As the ram body continues to move forward, the cup is moved through the redraw die. As the opening in the redraw die is smaller than the original diameter of the cup, the cup is deformed and becomes elongated with a smaller diameter. The wall thickness of the cup, typically, remains the same as the cup passes through the redraw die. As the ram continues to move forward, the elongated cup passes through a number of ironing dies. Each ironing die thins the wall thickness of the cup. The final forming of the can body occurs when the bottom of the elongated cup engages the domer, creating a concave dome in the cup bottom. At this point, and compared to the original shape of the cup, the can body is elongated, has a thinner wall, and a domed bottom. This process is repeated as the ram body reciprocates. That is, the ram travels toward, and through, the die pack on a forward stroke, and, travels backwards through the die pack and away from the die pack on a return stroke.

After the forming operations on the can body are complete, the can body is ejected from the ram, and more specifically the punch, for further processing, such as, but not limited to trimming, necking, washing, printing, flanging, inspecting, and placed on pallets, which are shipped to the filler.

FIG. 4 illustrates an example of a necker machine 1000 which reduces the cross-sectional area of a portion of a can body sidewall, i.e., at the open end of the sidewall. That is, prior to coupling a can end to the can body (and prior to filling), the diameter/radius of the can body sidewall open end is reduced relative to the diameter/radius of other portions of the can body sidewall. The example necker machine 1000 generally includes a frame assembly 1030 having an upstream end 1032 and a downstream end 1034 and a plurality of modules 1011 (six modules are shown in FIG. 4) coupled together in a side by side arrangement. The plurality of modules 1011 includes an infeed module 1012 positioned at a first end of the necker machine 1000. The infeed module 1012 includes an infeed assembly 1013 for receiving can bodies. The plurality of modules 1011 also includes a plurality of forming/processing modules 1014 extending side by side in a series arrangement from the infeed module 1012. The plurality of modules 1011 concludes with a discharge module 1015 positioned at the opposite end of the necker machine 1000 from the infeed module 1012 such that the plurality of processing modules 1014 are bounded by the infeed module 1012 and the discharge module 1015. The discharge module 1015 includes an exit assembly 1016 for discharging necked cans from the necker machine 1000. The processing and/or forming modules are disposed adjacent to each other and a transfer assembly 1018 driven by a drive assembly 1020 moves a can body between adjacent processing and/or forming modules. As the can body moves through the processing and/or forming modules 1014 the can body is processed or formed. The can bodies may also undergo, e.g., without limitation, flanging, decorating, etc.

An example can decorator 10 is illustrated in FIG. 2. A can decorator 10 is used for decorating cans and may include an infeed conveyor 15, which receives cans 16 from a can supply (not shown) and directs them to arcuate cradles or pockets 17 along the periphery of spaced parallel rings secured to a pocket wheel 12. The pocket wheel 12 is secured to a continuously rotating mandrel carrier wheel 18, which in turn is keyed to a continuously rotating horizontal drive staff 19. Downstream from the infeed conveyor 15, each spindle or mandrel is in closely spaced axial alignment with an individual pocket 17, and undecorated cans 16 are transferred from the pockets 17 to the mandrels. Suction applied through an axial passage of the mandrel draws the can 16 to a final seated position on the mandrel. While mounted on a mandrel, each can 16 is decorated by being brought into engagement with a blanket (e.g., without limitation, a replaceable adhesive-backed piece of rubber) disposed on a blanket wheel of the multicolor printing unit indicated generally by reference numeral 22. While moving toward engagement with an undecorated can 16, the blanket wheel engages a plurality of plate cylinders 31, each of which is associated with an individual inking station 32 (an exemplary eight inking stations 32 are shown in FIG. 2). Typically, each inking station 32 provides a different color ink and each plate cylinder 31 applies a different ink image segment to the blanket. All of the “ink image” segments combine to produce a “main image” that is structured to be applied to the can body. The “main image” is then transferred to undecorated cans 16 and becomes, as used herein, the “can body applied image.” Thereafter, and while still mounted on the mandrels, the outside of each decorated can 16 is coated with a protective film of varnish applied by engagement with the periphery of a varnish applicator roll (not shown) rotating on a shaft 23 in the overvarnish unit indicated generally by reference numeral 24. Cans 16 with decorations and protective coatings thereon are then transferred from the mandrels to suction cups (not shown) mounted adjacent the periphery of a transfer wheel (not shown) rotating on a shaft 28 of a transfer unit 27. From the transfer unit 27 the cans 16 are deposited on generally horizontal pins 29 carried by a chain-type output conveyor 30, which carries the cans 16 through a curing oven (not shown).

During the can manufacturing process, can bodies are inspected for defects, e.g., without limitation, dents in the can bodies, deformed necks or flanges, image defects (e.g., without limitation, skewed, misprinted, or inefficient levels of ink), etc., before being placed on the pallets which are then shipped to a filler. At the filler, the cans are taken off of the pallets, filled, have ends placed on them, and then are typically repackaged in various quantities (e.g., six packs, twelve pack or other multi-can cases, etc.) for sale to the consumer.

Currently, defects in cans may be detected by vision systems, e.g., cameras or manually. The vision systems generally include, e.g., without limitation, cameras disposed adjacent to or in an equipment for detecting defective cans. For example, can decorators may include a camera located at a pin chain (e.g., the output conveyor 30), a transfer wheel, or inside a curing oven for inspecting images on the cans. The camera captures images of cans as they pass through an inspection window and the images may be used to determine the quality of images printed on the cans and determine, for example, image registration, ink density, ink color, ink smearing, other image defects. However, imaging processing using such vision systems take significant time and computing power to, e.g., without limitation, train based on sample, historical and real-time data collected. Further, they may have a limited capabilities, e.g., depth perception, such that they may not accurately detect defects in cans.

There is room for improvement in detecting defects in cans during the can manufacturing process.

### SUMMARY OF THE INVENTION

These needs, and others, are met by a LiDAR (Light Detection and Ranging) detection system for use in a can manufacturing assembly. The LiDAR defect detection system includes a plurality of LiDAR sensors disposed at outputs of one or more equipment in the can manufacturing assembly and structured to scan and create at least three-dimensional (3D) images of output cans at the outputs of the one or more equipment; and a controller communicatively coupled to the LiDAR sensors and structured to collect data including at least the 3D images and analyze the data to determine if one or more output cans are defective.

Another example embodiment of the disclosed concept provides a LiDAR defect detection system for a can decorator. The LiDAR defect detection system includes one or more LiDAR sensors disposed adjacent to or within a component of the can decorator, the one or more LiDAR sensors structured to scan and create at least three-dimensional (3D) images of cans passing through an inspection window of the one or more LiDAR sensors; and a controller communicatively coupled to the one or more LiDAR sensors and structured to collect data including at least the 3D images and analyze the data to determine if one or more cans are defective.

Yet another example embodiment of the disclosed concept provides a method of detecting a defect in cans in a can manufacturing assembly. The method includes providing a LiDAR defect detection system that comprises (i) LiDAR sensors disposed at outputs of one or more equipment in the can manufacturing assembly and structured to scan and create at least three-dimensional (3D) images of output cans at the outputs of the one or more equipment, and (ii) a controller communicatively coupled to the LiDAR sensors and structured to collect data including at least the 3D images and analyze the data to determine if one or more output cans are defective; scanning and creating at least the 3D images by the LiDAR sensors; transmitting, by the LiDAR sensors, the data including at least the 3D images to the controller; and analyzing, by the controller, the data received to determine if one or more output cans are defective.

### BRIEF DESCRIPTION OF THE DRAWINGS

A full understanding of the invention can be gained from the following description of the preferred embodiments when read in conjunction with the accompanying drawings in which:

FIG. 1 is an exemplary LiDAR defect detection system for a can manufacturing assembly according to a non-limiting, example embodiment of the disclosed concept;

FIG. 2 is an exemplary can decorator having a LiDAR defect detection system according to a non-limiting, example embodiment of the disclosed concept;

FIG. 3 is an exemplary bodymaker for forming a can body having a base and a can body sidewall;

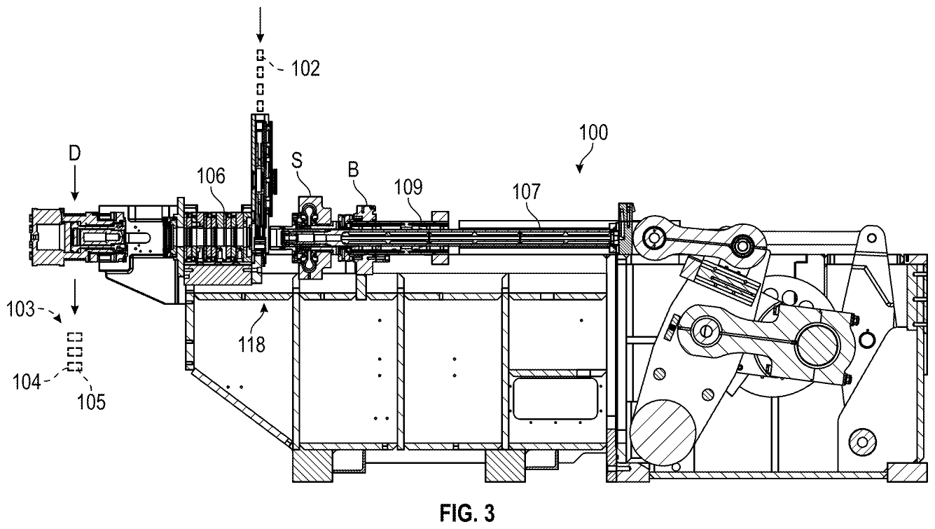

FIG. 4 is an exemplary necker machine for reducing a cross-sectional area of an open end of a can body sidewall; and

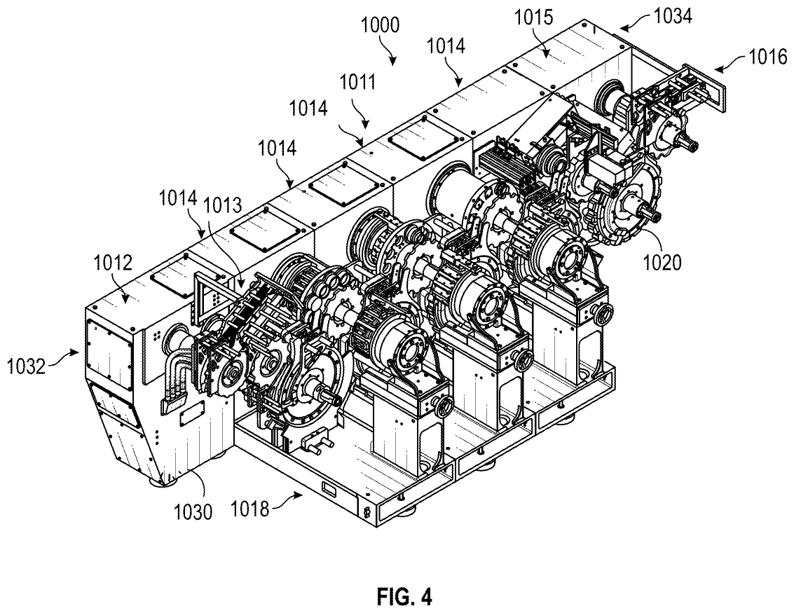

FIG. 5 is a flow chart for a method of detecting a defect in cans using an exemplary LiDAR defect detection system.

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together or act upon/with each other in some manner. For example, an automobile has four tires and four hub caps. While all the elements are coupled as part of the automobile, it is understood that each hubcap is “associated” with a specific tire.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. As used herein, “adjustably fixed” means that two components are coupled so as to move as one while maintaining a constant general orientation or position relative to each other while being able to move in a limited range or about a single axis. For example, a doorknob is “adjustably fixed” to a door in that the doorknob is rotatable, but generally the doorknob remains in a single position relative to the door. Further, a cartridge (nib and ink reservoir) in a retractable pen is “adjustably fixed” relative to the housing in that the cartridge moves between a retracted and extended position, but generally maintains its orientation relative to the housing. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, an “elongated” element inherently includes a longitudinal axis and/or longitudinal line extending in the direction of the elongation.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

Example embodiments of the disclosed concept provide a LiDAR (light detection and ranging) defect detection system and method of detecting defects in cans in a can manufacturing assembly. The LiDAR defect detection system according to the disclosed concept is novel in that it uses one or more LiDAR sensors for detecting defects in cans, rather than using vision systems (e.g., without limitation, cameras) or manual inspection. The LiDAR defect detection system provides a clearer 3D depiction of the cans that can be utilized to detect defects in the cans more accurately than the conventional vision systems can. For example, since the LiDAR sensors provide data including specifics (e.g., the size, distance, or depth) of the detected defect, the LiDAR defect detection system can determine whether the detected defect is an actual defect by comparing the size, distance or depth of the detected defect to reference size, distance or depth for corresponding portion of the cans. That is, the can is defective if the size, distance or depth of the detected defect does not conform to the reference size, distance or depth of the corresponding area of the cans. In some examples, if the size, distance or depth of the detected defect falls within a predetermined threshold that satisfies the reference size, distance or depth of the corresponding portion, then the can is not defective. Further, because of the ability to provide data including the specifics of captured images of the cans, the LiDAR defect detection system can accurately and quickly determine whether any part of the printed images on the cans is misaligned, skewed, or erroneously registered based on the data. Such detection of defects by the LiDAR defect detection system is advantageous over the conventional vision systems which may not provide the specifics such as the size, distance, depth or image appearance to the degree of accuracy as the LiDAR sensors can. Furthermore, the LiDAR defect detection system does not use a significant computing powers that the conventional visual systems requires for training.

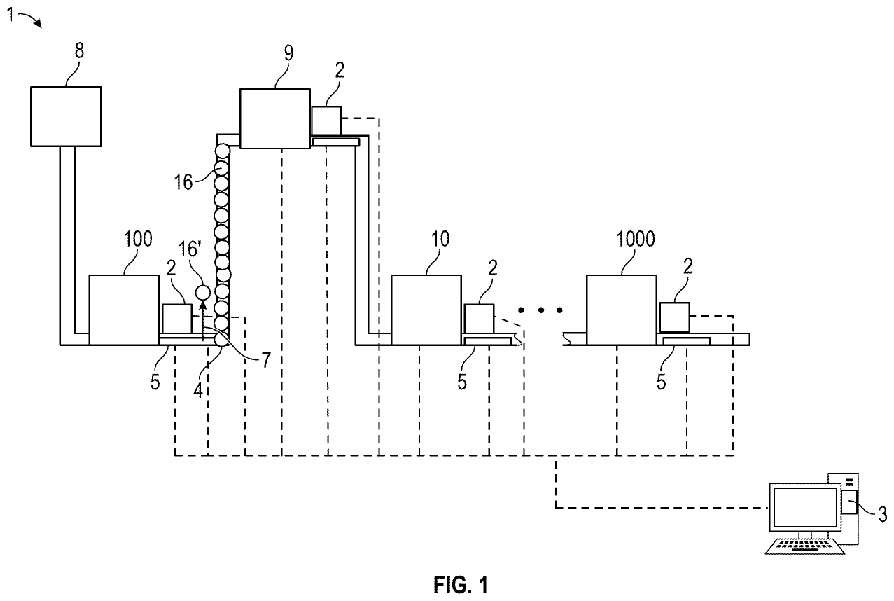

FIG. 1 illustrates a LiDAR defect detection system 1 for a can manufacturing assembly according to a non-limiting, example embodiment of the disclosed concept. The can manufacturing assembly includes a plurality of equipment performing various stages of the can manufacturing process. While FIG. 1 shows that the can manufacturing assembly includes a cupper 8, a bodymaker 100, a trimmer 9, a necker machine 1000, and a can decorator 10, it is to be understood that the can manufacturing assembly may include other equipment such as a washer, a flanging machine, a filler and other appropriate can manufacturing equipment. Further, while FIG. 1 shows a plurality of the equipment coupled to one another successively throughout the can manufacturing assembly at one facility, one or more equipment may be located at different facilities such that the output cans 16 need to be shipped to the equipment performing the next stage of the can manufacturing process. For example, the cans 16 decorated by the can decorator 10 may be transported to a filler (not shown) located at another facility. In addition, while the conveyor 4 extends vertically and/or horizontally in FIG. 1, it may extend in any possible directions as appropriate. In addition, while FIG. 1 shows the equipment being coupled to one another via one conveyor 4, it is to be understood that the conveyor 4 may be an output conveyor of each equipment that is separate and apart from other equipment.

Referring back to FIG. 1, the LiDAR defect detection system 1 includes a plurality of LiDAR sensors 2 and a controller 3 communicatively coupled to the LiDAR sensors 2. The LiDAR sensors 2 are disposed at an output conveyor 4 of respective equipment in the can manufacturing assembly. A number of the LiDAR sensors 2 to be disposed may vary at each equipment or manufacturing stage as appropriate. The LiDAR sensors 2 may be disposed above the cans 16 being carried on the conveyor 4 as the cans 16 are being output from each equipment such that the LiDAR sensors 2 may capture three-dimensional (3D) images of the output cans 16 from above. In some examples, the LiDAR sensors 2 may be disposed also at an input conveyor of each equipment. For example, the LiDAR sensors 2 may be placed at an input of a necker machine 1000 in order to determine if trimming was performed correctly by a trimmer before necking and also at an output of the necker machine 1000 in order to determine if necking has been performed correctly. In some examples, the LiDAR sensors 2 may be disposed on or below the conveyor 4. In some examples, the LiDAR sensors 2 may be disposed above the output cans 16 as well as below the output cans 16 or on the conveyor 4. In some examples, the LiDAR sensors 2 may be disposed adjacent to or within one or more components of an equipment, e.g., without limitation, a can decorator. In some examples, a plurality of LiDAR sensors 2 may be disposed at various angles at the end of the assembly line to determine if each finished can has been manufactured and completed correctly at every stage.

The LiDAR sensors 2 are structured to scan and create 3D images of all sides of the cans 16 being output onto the conveyor 4 from each equipment. In some examples, the LiDAR sensors 2 may create 2D images of the cans 16. The LiDAR sensors 2 emit light, receive reflected light, determine distance based on the time it takes to receive the reflected light, and scans the output cans 16 to create the 3D images of the cans 16. The LiDAR sensors 2 then transmit data including at least the 3D images and the distances to the controller 3 that is communicatively coupled to the LiDAR sensors 2 in a wired or wireless connection.

The controller 3 may be, for example and without limitation, a microprocessor, a microcontroller, or some other suitable processing device or circuitry. It may include memory, which can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. The controller 3 is structured to receive and analyze the data received from the LiDAR sensors 2 to determine if one or more output cans 16 include a defect. The controller 3 may analyze the data to determine the quality of the cans 16 at each stage of the can manufacturing process. For such determination, the controller 3 may compare the data with the specifications (e.g., without limitation, the reference sizes, distances, angles and images) for the cans 16 being manufactured at each stage, e.g., without limitation, considering possible defects at each equipment and respective equipment technologies, ages, usages, and environments. Upon such comparison, the controller 3 may determine whether defects have been detected in one or more output cans 16 and whether the detected defects are actual defects requiring removal of the defective cans 16′ from the conveyor 4. In some examples, an actual defect is any defect that does not conform to the reference specifications. In some examples, an actual defect may be a defect that exceeds an acceptable threshold for respective specification using respective equipment. The acceptable threshold may be set and stored by, e.g., without limitation, the equipment manufacturer or operators based on sample data using the equipment. If the controller 3 determines that the detected defects are indeed actual defects (e.g., without limitation, a dent, ink smearing, or misaligned registration beyond respective acceptable thresholds), the controller 3 may cause a removal device 5 operatively coupled to the conveyor 4 to remove the defective cans 16′ from the conveyor 4. The removal device 5 may be communicatively coupled to the controller 3 and structured to remove the defective cans 16′ by, e.g., without limitation, applying air pressure outwardly and directly at the defective cans 16′ as shown by the arrow 7. Alternatively, if the controller 3 determines the detected defect is not an actual defect (e.g., without limitation, a rib formed correctly according to respective specification, but shown differently due to, e.g., without limitation, angles of light or specific structures of the equipment in use), the controller 3 may ignore the detected defect. The controller 3 may be a main controller for the can manufacturing assembly that is communicatively coupled to equipment controllers (e.g., a microcontroller, a CPU, etc.) for respective equipment and structured to control the can manufacturing assembly as a whole as shown in FIG. 1. Alternatively, the controller 3 may be an equipment controller (e.g., without limitation, a processing unit including a memory) of respective equipment, and includes a set of instructions for detecting defects in the output cans 16.

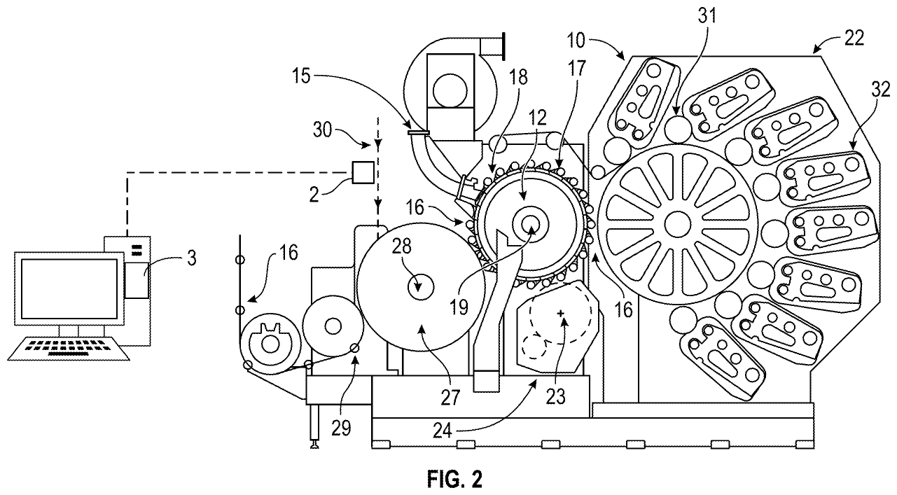

FIG. 2 illustrates a can decorator 10 having the LiDAR defect detection system 1 of FIG. 1 according to a non-limiting, example embodiment of the disclosed concept. In FIG. 2, one or more LiDAR sensors 2 are disposed adjacent to a chain-type output conveyor 30 of the can decorator 10. It is to be understood that the one or more LiDAR sensors 2 may be disposed at any suitable location (e.g., without limitation, in a transfer wheel (not shown), inside a curing oven (not shown), etc.) of the can manufacturing process without departing from the scope of the disclosed concept. The cans 16 are carried by rotating can pads (not shown) through an inspection range (i.e., an inspection window) of the LiDAR sensors 2. The rotating can pads rotate the cans 16 through at least a full 360 degree rotation while the cans 16 move through the inspection window. Thus, the one or more LiDAR sensors 2 are able to scan and create 3D images of all sides of each can 16 passing through the inspection window. The one or more LiDAR sensors 2 then transmit data including the 3D images to the controller 3, which in turn uses the data to determine if a defect (e.g., without limitation, an image registration error) has been detected in one or more cans 16. In response to a determination that a defect has been detected in the one or more cans 16, the controller 3 determines the detected defect is an actual defect. In response to a determination that the detected defect is an actual defect, the controller 3 causes the defective cans 16′ to be removed from the conveyor 30 by a removal device (not shown).

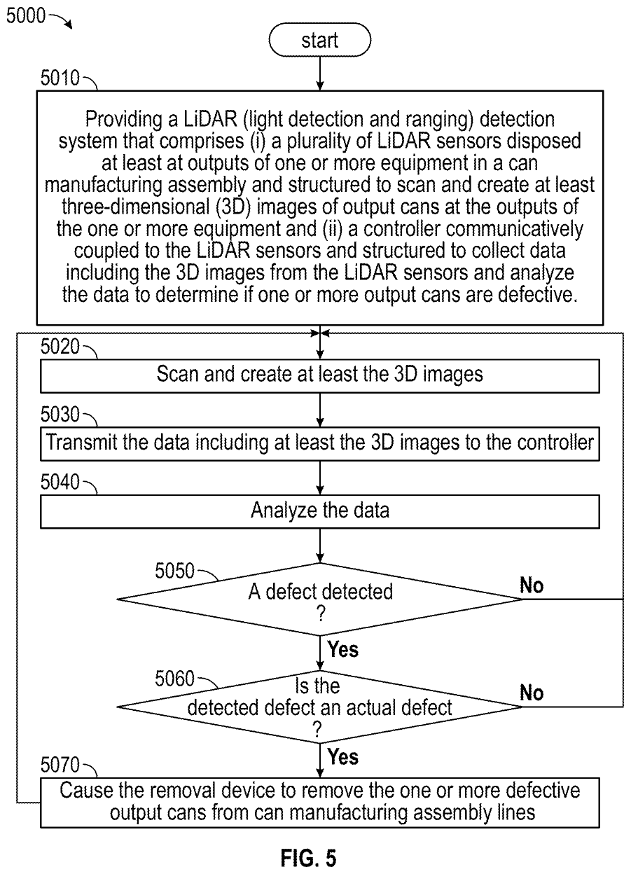

FIG. 5 is a flow chart for a method 5000 for detecting a defect in cans using a LiDAR defect detection system according to a non-limiting, example embodiment of the disclosed concept. The LiDAR defect detection system is similar to the LiDAR defect detection system 1 as described with reference to FIGS. 1-2. The method 5000 may be performed by the LiDAR defect detection system 1 or the components thereof.

At 5010, a LiDAR defect detection system is provided in a can manufacturing assembly. The LiDAR defect detection system includes a plurality of LiDAR sensors disposed at outputs of one or more equipment in a can manufacturing assembly and structured to scan and create at least three-dimensional (3D) images of output cans at the outputs of the one or more equipment. The LiDAR defect detection system also includes a controller communicatively coupled to the LiDAR sensors and structured to collect data including at least the 3D images from the LiDAR sensors and analyze the data to determine if one or more output cans are defective.

At 5020, the LiDAR sensors scan and create at least the 3D images of the output cans.

At 5030, the LiDAR sensors transmit the data including at least the 3D images to the controller.

At 5040, the controller analyzes the data. For example, the controller compares the data with specifications for the output cans.

At 5050, the controller determines if a defect has been detected in one or more output cans. If yes, the method 5000 returns to 5020. If no, the method 5000 proceeds to 5060.

At 5060, the controller determines if the detected defect is an actual defect. For example, the controller determines if the detected defect is an actual defect beyond an acceptable threshold (e.g., a dent or an image defect beyond respective thresholds). If no, the method 5000 returns to 5020. If yes, the method 5000 proceeds to 5070.

At 5070, the controller causes the removal device to remove the one or more defective output cans from can manufacturing assembly lines. The method 5000 then returns to 5020.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A LiDAR (Light Detection and Ranging) defect detection system for use in a can manufacturing assembly, comprising:
a plurality of LiDAR sensors disposed at least at outputs of one or more equipment in the can manufacturing assembly and structured to scan and create at least three-dimensional (3D) images of output cans at the outputs of the one or more equipment; and
a controller communicatively coupled to the LiDAR sensors and structured to collect data including at least the 3D images and analyze the data to determine if one or more output cans are defective.

2. The system of claim 1, wherein the one or more equipment comprise at least one of a bodymaker, a trimmer, a necker machine, a washer or a can decorator.

3. The system of claim 1, wherein the controller is further structured to compare the data with specifications for the output cans.

4. The system of claim 1, wherein the outputs comprise one or more conveyors that carry the output cans processed by each equipment.

5. The system of claim 4, wherein the LiDAR sensors are disposed above the output cans.

6. The system of claim 5, wherein the LiDAR sensors further comprise one or more LiDAR sensors disposed below the output cans or on the one or more conveyors.

7. The system of claim 5, wherein the LiDAR sensors further comprise one or more LiDAR sensors disposed in the one or more equipment.

8. The system of claim 7, wherein the one or more LiDAR sensors are disposed in a pin chain, a transfer wheel, or a curing oven of a can decorator.

9. The system of claim 4, wherein for analyzing the data, the controller is further structured to compare the data with specifications for the output cans, the specifications comprising at least reference sizes and reference images for the output cans.

10. The system of claim 9, wherein the controller determines if a defect has been detected in one or more output cans based on the comparison and determine if the detected defect is an actual defect based at least in part on the specifications.

11. The system of claim 10, wherein an actual defect exceeds an acceptable threshold for respective specification using respective equipment.

12. The system of claim 11, wherein the one or more conveyors are operably coupled to respective removal devices that are communicatively coupled to the controller, the removal devices being structured to remove the one or more defective cans from the one or more conveyors and wherein the controller is further structured to cause the removal device to remove the one or more defective cans from the one or more conveyors based on the determination that the defect is an actual defect.

13. The system of claim 1, wherein the data from the LiDAR sensors further comprise at least distance information associated with the output cans.

14. A LiDAR (Light Detection and Ranging) defect detection system for use in a can decorator, comprising:
one or more LiDAR sensors disposed adjacent to or within a component of the can decorator, the one or more LiDAR structured to scan and create at least three-dimensional (3D) images of cans passing through an inspection window of the one or more LiDAR sensors; and
a controller communicatively coupled to the one or more LiDAR sensors and structured to collect data including at least the 3D images and analyze the data to determine if one or more cans are defective.

15. The system of claim 14, wherein the controller is further structured to compare the data including at least the 3D images to at least reference images for the cans in determining if one or more cans include an image defect, the image defect comprising an image registration error.

16. The system of claim 14, wherein an output conveyor of the can decorator is operably coupled to a removal device that is communicatively coupled to the controller and structured to remove the one or more defective cans.

17. The system of claim 16, wherein in response to determining that one or more cans include an image defect, the controller is further structured to cause the removal device to remove the one or more defective cans from the output conveyor.

18. The system of claim 14, wherein the cans are carried by rotating can pads through the inspection window such that the one or more LiDAR sensors are able to scan and create images of all sides of each can passing through the inspection window.

19. A method of detecting a defect in cans in a can manufacturing assembly, comprising:
providing a LiDAR (Light Detection and Ranging) defect detection system that comprises (i) LiDAR sensors disposed at least at outputs of one or more equipment in the can manufacturing assembly and structured to scan and create at least three-dimensional (3D) images of output cans at the outputs of the one or more equipment, and (ii) a controller communicatively coupled to the LiDAR sensors and structured to collect data including at least the 3D images and analyze the data to determine if one or more output cans are defective;
scanning and creating at least the 3D images;
transmitting the data including at least the 3D images to the controller; and
analyzing the data received to determine if one or more output cans are defective.

20. The method of claim 19, wherein the determining if one or more output cans are defective comprises:
comparing the data to specifications for the output cans, the specifications including at least reference sizes and reference images for the output cans;
detecting a defect in one or more output cans based on the comparison;
determining if the detected defect is an actual defect; and
in response to determining that the detected defect is an actual defect, causing a removal device to remove the one or more defective output cans from can manufacturing assembly line.
